(19) United States
(12) Patent Application Publication
(10) Pub. No.: US 2011/0020215 A1
(43) Pub. Date: Jan. 27, 2011

(54) Chemical hydride formulation and system design for controlled generation of hydrogen

(76) Inventors: WonHyoung Ryu, Yongin (KR); Daniel Braithwaite, San Francisco, CA (US); Tibor Fabian, Mountain View, CA (US)

Correspondence Address: SCHOX PLC, 500 3rd Street, Suite 515, San Francisco, CA, 94107, US

(21) Appl. No.: 12/460,794

(22) Filed: Jul. 23, 2009

(51) Int. Cl. C01B 3/04; C01B 3/00

(52) U.S. Cl. 423/658.2; 423/648.1

(57) ABSTRACT

A chemical hydride liquid reactant distribution mixture is provided. The mixture includes a fuel mixture having at least one hydride and at least one activating agent. The invention further includes a liquid-distributing agent (LDA), a form-stabilizing agent, and at least one anti-caking agent. The liquid reactant distribution mixture reduces caking and precipitation while promoting liquid reactant distribution, where the chemical hydride liquid reactant distribution mixture generates hydrogen via hydrolysis.

### FIELD OF THE INVENTION

The invention relates generally to fuel cells. More particularly, the invention relates to chemical hydride liquid reactant distribution mixtures for reducing caking and precipitation while promoting liquid reactant distribution.

### BACKGROUND

Fuel cells, as an alternative source of electric energy, have been explored extensively. However, due to the lack of proper storage means of a fuel, hydrogen in most cases, applications of fuel cell systems for commercial products have been limited. In particular, for mobile applications such as laptops, mp3 players, or cellular phones, demand for portable hydrogen storage that is safe and high in energy density has grown significantly. Among many chemical hydride systems, sodium borohydride (SBH) as a source of hydrogen has been the most studied and understood. SBH reacts with water and becomes hydrolyzed releasing molecular hydrogen gas. This SBH hydrolysis is typically accelerated using catalytic materials or acids.

SBH-based hydrogen generator systems are known. A system has been described that generates hydrogen by feeding an alkaline-buffered SBH solution into catalytic beads. Although this system has an advantage in improved control of hydrogen reaction, the system energy density is relatively low due to its low solubility in a solvent (water mainly) and long-term stability. The low solubility of SBH allows only a fraction of solid SBH to dissolve in water, in the range of 10 and 20% concentration at best, at a room temperature. In addition, need for extra materials (e.g. sodium hydroxide) to stabilize the fuel leads to increased complexity of the system and a decrease in overall energy density. In addition, it is possible that fuel reactants or products may change its phase from a liquid to solid by precipitation under varying temperature and pressure conditions. This phase change may result in precipitation at unwanted locations, leading to the failure of the entire system.

Another hydrogen generator system has been described that uses a solid form of the chemical hydride. One example is a system that contains micro-particles of sodium borohydride mixed with catalyst materials. In this system, a fuel chamber is connected to a separate chamber that provides water as a liquid reactant to the fuel chamber. Another example is a cartridge system containing a substantially anhydrous chemical hydride reactant and liquid conduits. A liquid reactant is delivered to the chemical hydride via the liquid conduits. Although this method intends to provide control of the reactant liquid using spatial and form-factor variation of the conduits, construction of such a system may become complex and also lead to decrease in total energy density of the system. In addition, this system has not addressed serious issues such as the caking and precipitation of reaction products, which are detrimental to the performance of any hydrogen system based on solid chemical hydride. Furthermore, despite the high energy density of SBH material itself, the energy density of a hydrogen generator system using the SBH often decreases due to added components or increased volume of the system for reaction control and product filtration. Thus, it is also important to miniaturize these additional components and related system architecture without sacrificing the reliable performance of a SBH-based hydrogen system.

What is needed is a hydrogen system that suffices to meet goals of high energy density, controllability, and no risk of caking and precipitation at the same time.

### SUMMARY OF THE INVENTION

The present invention provides a chemical hydride liquid reactant distribution mixture. The mixture includes a fuel mixture having at least one hydride and at least one activating agent. The invention further includes a liquid-distributing agent (LDA), a form-stabilizing agent, and at least one anti-caking agent. The liquid reactant distribution mixture reduces caking and precipitation while promoting liquid reactant distribution, where the chemical hydride liquid reactant distribution mixture generates hydrogen via hydrolysis.

According to one aspect of the invention, the LDA can include hydrophilic polymers, carbohydrates or sugar alcohols.

In one aspect the hydrophilic polymer includes poly alkyl (acrylic) acid and its salt, where the poly alkyl (acrylic) acid and its salt can include poly(acrylic acid), poly(α-ethylacrylic acid), poly(α-propylacrylic acid), poly(methacrylic acid), poly(sodium acrylate), poly(sodium methacrylate), poly(2-hydroxyethyl methacrylate), or polyacrylamide.

In another aspect, the hydrophilic polymers can include poly(N,N-dimethyl acrylamide), poly(N-isopropyl acrylamide), poly(ethylene glycol) or poly(ethylene oxide). Here, the poly(ethylene glycol) and poly(ethylene oxide) can include poly(ethylene glycol) methylether (initiator based on methoxy ethanol), poly(ethylene glycol) with disulfide linkage, poly(ethylene glycol) methylether (initiator based on 2-methoxy propanol), poly(ethylene glycol) monoethyl ether (nitiator based on ethoxy ethanol), poly(ethylene glycol) dimethyl ether, poly(ethylene glycol) mono-benzylether, poly(ethylene glycol) dibenzylmethylene terminated (initiator based on diphenyl methylene), poly(ethylene glycol) dimethylamine and hydroxy terminated, poly(ethylene glycol) dimethylamine or methoxy terminated.

In a further aspect, the hydrophilic polymers can include poly(methyl vinyl ether), poly(2-vinyl N-methylpyridinium iodide), poly(4-vinyl N-methylpyridinium iodide), poly(N-vinyl imidazole-quaternized with CH3I), poly(ethylene imine), poly(vinylamine) with poly(vinyl carboxylic acid amide), or poly(styrene sulfonic acid) and its salt. Here, the poly(styrene sulfonic acid) and its salt can include poly(styrene sulfonic acid) dialysed, poly(styrene sulfonic acid), undialysed, poly(styrene sulfonic acid cesium salt), dialysed, poly(styrene sulfonic acid cesium salt), undialysed, poly(styrene sulfonic acid sodium salt), dialysed, poly(styrene sulfonic acid sodium salt), or undialysed poly(vinyl alcohol). Further, the poly(vinylamine) and poly(vinyl carboxylic acid amide) can include poly(N-vinylamine), poly(N-vinyl formamide), poly(N-vinyl isobutyramide), or poly(N-vinyl pyrrolidone).

In another aspect of the invention, the carbohydrates can include monosaccharides such as glucose, fructose, galactose, xylose, ribose disaccharides such as sucrose or polysaccharides such as cellulose, starch, chitin, dextran (dextrin), or maltodextrin.

In another aspect of the invention, the sugar alcohols can include glycol, glycerol, erythritol, threitol, arabitol, xylitol, ribitol, mannitol, sorbitol, dulcitol, iditol, isomalt, maltitol, lactitol, or polyglycitol.

According to one aspect of the invention, the LDA further has material that can include microcrystalline cellulose, carboxymethyl cellulose, methyl cellulose, alginic acid, dibasic calcium phosphate, dextrates, calcium sulfate dehydrate, or compressible sucrose.

In a further aspect, the LDA includes a weight percentage of the liquid reactant distribution mixture in a range from 0.1 to 50 percent.

In another aspect of the invention, the form-stabilizing agent can include starch, methyl cellulose, hypromellose, microcrystalline cellulose, dibasic calcium phosphate, dextrate, sucrose, or polyethylene glycol.

In yet another aspect, the at least one anti-caking agent can include magnesium carbonate, calcium carbonate, silica (silicon dioxide), sodium bicarbonate, sodium ferrocyanide, potassium ferrocyanide, calcium ferrocyanide, bone phosphate, sodium silicate, calcium silicate, magnesium trisilicate, talcum powder, sodium aluminosilicate, potassium aluminium silicate, calcium aluminosilicate, bentonite, aluminium silicate, stearic acid, or polydimethylsiloxane.

In another aspect, the at least one anti-caking agent has a weight percentage of the liquid reactant distribution mixture in a range from 0.1 to 10 percent.

According to another aspect of the invention, the at least one hydride can include sodium borohydride, lithium borohydride, lithium aluminum hydride, lithium hydride, sodium hydride, magnesium hydride, or calcium hydride.

In a further aspect, the at least one activating agent comprises a acidic catalyst wherein the acidic catalyst can include boric acid, malic acid, succinic acid, oxalic acid, citric acid, tartaric acid, malonic acid, boric oxide, mucic acid, calcium chloride, sodium borofluoride, phthalic acid, salicylic acid, alum, benzoic acid, phthalic anahydride, sulfamic acid, ammonium alum, ammonium chloride, maleic anahyrdride, sodium acid sulfate, sodium diacid phosphate, aluminum sulfate, maleic acid, calcium chloride or ammonium carbonate.

In another aspect, the at least one activating agent includes a metallic catalyst, where the metallic catalyst can include colloidal platinum, platinized asbestose, platinum oxidation catalyst, copper-chromic oxide, activated charcoal, Raney nickel, manganese(II) chloride, iron(II) chloride, cobalt(II) chloride, nickel(II) chloride, or copper(II) chloride.

In yet another aspect, the at least one activating agent includes at least one salt such as alkaline earth metals, alkali metals or halides.

In another aspect of the invention, the halides can include MgCl₂, BeF₂, BeCl₂, BeBr₂, BeI₂, MgF₂, MgBr₂, MgCl₂, MgI₂, CaF₂, CaCl₂, CaBr₂, CaI₂, LiF, LiCl, LiBr, LiI, NaF, NaCl, NaBr, NaI, KF, KCl, KBr, KI, Li₂S, or Li₂Se. Finally, other candidates of activating agents include at least one of Cu, Co, Ni, Pt, Pd, Fe, Ru, Mn, and Cr.

According to one embodiment, the invention is liquid reactant distribution mixture that includes a fuel, at least one accelerator, at least one liquid distributing agent (LDA), and at least one form-stabilizing agent or binder.

According to one aspect of the current embodiment, the at least one accelerator can include an acid accelerator, a metallic catalyst, a mixture of acidic and metallic accelerators, an acidic accelerator dissolved in a liquid reactant, a metallic accelerator dissolved in a liquid reactant, an acidic accelerator partially mixed in solid mixture and partially dissolved in liquid reactant, or a metallic accelerator partially mixed in solid mixture and partially dissolved in liquid reactant.

According to one aspect, the fuel is sodium borohydride.

In a further aspect, the at least one acidic accelerator can include oxalic acid, succinic acid, malonic acid, citric acid, tartic acid, malic acid, boric acid mucic acid, calcium chloride sodium borofluoride phthalic acid, salicylic acid, alum, bezoic acid, phthalic anhydride, sulfamic acid ammonium alum, ammonium chloride, maleic anhydride, sodium acid sulfate, sodium diacid phosphate, aluminum sulfate, or ammonium carbonate.

In another aspect of the invention, the at least one LDA can include hydrophilic polymers, carbohydrates, or sugar alcohols.

In a further aspect of the invention, the at least one form-stabilizing agent can include starch, methyl cellulose, hypromellose, microcrystalline cellulose, dibasic calcium phosphate, dextrate, sucrose, or polyethylene glycol.

According to another aspect, the liquid distribution mixture is compacted to form a solid structure, where the solid structure has a shape that can include a rod, a cylinder, a tube, a plate, a thin sheet, a block, micro-spheres, macro-spheres or powder form.

In another aspect, the liquid distribution mixture is uniformly mixed into a gel or paste.

In a further aspect of the invention, the liquid reactant distribution mixture further includes an anti-foam agent, where the anti-foam agent includes alcohols such as butyl alcohol, hexyl alcohol, or organosilicon compounds.

In another aspect, the organosilicon compounds can include polydimethylsiloxane, polyhydrosiloxane, and silica particles.

### BRIEF DESCRIPTION OF THE FIGURES

The objectives and advantages of the present invention will be understood by reading the following detailed description in conjunction with the drawing, in which:

FIG. 1 shows a schematic diagram of a hydrogen generation system according to the present invention.

FIGS. 2a-2b show a prior art schematic diagram of liquid distribution in a fuel mixture with liquid blocked by caking layer, and an enhanced liquid distribution in a fuel mixture containing anti-caking agents and LDA according to the present invention, respectively.

FIGS. 3a-3d show exemplary moving boundary interface (MBI) designs according to the present invention.

FIGS. 4a-4d show examples of product-guide design in a solid fuel mixture (cylindrical shape), according to the present invention.

FIGS. 5a-5c show examples of engineered guides for product disposal according to the present invention.

FIGS. 6a-6c show schematic diagrams of layout variations of product separation media according to the present invention.

FIG. 7 shows a schematic diagram of a multi-stage filter configuration according to the present invention.

FIGS. 8a-8b show a schematic diagram and a CAD model, respectively of a hydrogen generation system having a liquid reactant chamber, fuel chamber, filter chamber, and pump according to the present invention.

FIGS. 9a-9c show schematic diagrams of a preferred assembly of an LDM and fuel mixture in a form of a nozzle, plane, or envelope, respectively according to the present invention.

FIG. 10 shows a schematic diagram of a preferred embodiment of local thermal apparatus in fuel mixture for enhanced stop/start of hydrogen generation according to the present invention.

FIG. 11 shows a schematic diagram of a preferred embodiment of pre-heating of a liquid reactant before it reaches fuel mixture for enhanced stop/start of hydrogen generation according to the present invention.

FIG. 12 shows a graph of H₂ evolution profile of Mixture No. 1 (SBH 15 g, Succinic acid 15 g, Compressible sugar 1 g, Silica 0.3 g) according to the present invention.

FIG. 13 shows a graph of H₂ evolution profile of Mixture No. 6 (SBH 20 g, Malic acid 10 g, PEG 6000 1 g, Silica 0.3 g) according to the present invention.

FIG. 14 shows a graph of H₂ evolution profile of Mixture No. 7 (SBH 20 g, Malic acid 10 g, PEG6000 1 g, Silica 0.3 g) with orientation change at times of 1 hr 20 min, 2 hr 32 min, and 3 hr according to the present invention.

FIG. 15 shows a graph of H₂ evolution profile of H₂ generation system when planar type of LDM made of synthetic polypropylene felt was used according to the present invention.

FIG. 16 shows a graph of H₂ evolution profile of balloon membrane fuel reactor and serial filter set comprised of nylon wools and acryl yarn according to the present invention.

FIG. 17 shows an example of hydrogen evolution profile of H₂ pack with elastic enclosure during dynamic test with 20 min On/20 min Off cycle according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention provides a hydrogen generator system optimized for portable applications with the emphasis on novel fuel mixture that enhances the energy density, controllability, low cost, safety, and environmental friendliness. In addition, for system miniaturization, this invention also presents system architectures, reaction control mechanisms and their appropriate materials, and filtration designs and their suitable materials. In particular, these inventions are optimized for the non-liquid fuel mixture described above.

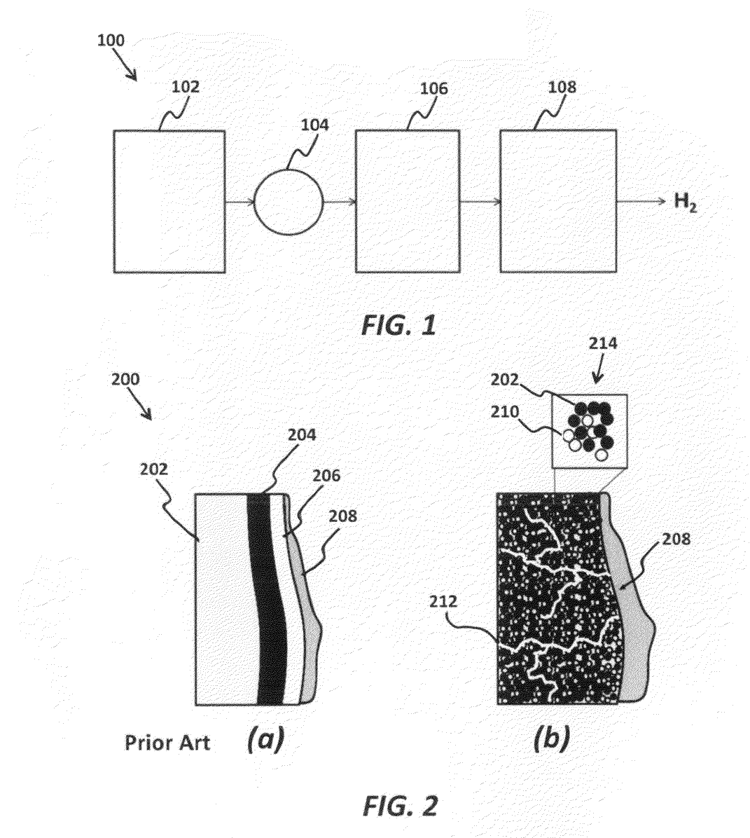

FIG. 1 shows a schematic diagram of a hydrogen generator system 100 having storage 102 for a liquid reactant, a pump 104, a fuel/reaction chamber 106, and product separation media 108, according to the present invention. The reaction chamber 106 contains (not shown) a fuel mixture and reaction control mechanism including liquid delivery media (LDM) and means to localize sodium borohydride (SBH) reaction. The fuel mixture is in its non-liquid form such as powder, particles, compacted solid, slurry, or paste. The LDM can be a nozzle, wick, spray, or tube . . . etc, and can be either in contact or proximate to the fuel mixture. A reactant liquid (preferably deionized or distilled water) is delivered via a pump 104 to the fuel mixture to initiate the hydrolysis of a fuel to generate hydrogen. Hydrogen generation rate is mainly controlled by the pumping rate of a liquid reactant into a reaction chamber 106. At a controlled pumping rate, a liquid reactant enters into a reaction chamber guided by an LDM and hydrolysis reaction is initiated at its interface with a fuel mixture. Delivery of a liquid reactant to a fuel mixture can be achieved by direct injection, dripping, spraying, or wetting of an LDM. An LDM can be a rigid or flexible medium including single or multiple of rods, tubes, bars, or sheets. The SBH hydrolysis produces a mixture of boron oxide precipitates, viscous paste of additives, and hydrogen gas. This mixed product is filtered through product separation media allowing only hydrogen gas to leave the system.

The current invention further includes non-liquid hydrogen fuel mixtures optimized for the use of the system described above. The fuel mixtures were designed to enhance the distribution of a liquid reactant throughout the entire volume of the fuel mixture to minimize any caking or precipitation. The product of SBH reaction, sodium borate, is known to cause caking, which creates a thick and hard solid layer that eventually blocks liquid access to the unreacted portion of a fuel mixture. FIGS. 2a-2b show schematic diagrams of liquid distribution in a fuel mixture 200. FIG. 2a shows a prior art schematic diagram of liquid distribution in a fuel mixture 202 with liquid reactant 208 blocked by caking layer 204 caused by the product 206 of SBH hydrolysis. In order to prevent this caking phenomenon anti-caking agents (not shown) are included in the fuel mixture in the weight percentage of between 0.1 and 10% of the whole fuel mixture, according to the current invention. Anti-caking agent can include magnesium carbonate, calcium carbonate, silica (silicon dioxide), sodium bicarbonate, sodium ferrocyanide, potassium ferrocyanide, calcium ferrocyanide, bone phosphate, sodium silicate, calcium silicate, magnesium trisilicate, talcum powder, sodium aluminosilicate, potassium aluminium silicate, calcium aluminosilicate, bentonite, aluminium silicate, stearic acid, or polydimethylsiloxane. In addition, as shown in FIG. 2b, liquid distribution in the fuel mixture is improved by adding strongly hydrophilic substances (liquid distributing agents, LDA) 210 such as hydrophilic polymers, carbohydrates, and sugar alcohols, in the weight percentage of between 0.1 and 50%, where liquid paths 212 are formed in the liquid reactant fuel mixture 214. When it is necessary to form a stable solid object, a binder substance (not shown) is included in the liquid reactant fuel mixture 214. Common binders suitable for this purpose include, but are not limited to, microcrystalline cellulose, carboxymethyl cellulose, methyl cellulose, alginic acid, dibasic calcium phosphate, dextrates, calcium sulfate dehydrate, or compressible sucrose.

According to the current invention, a non-liquid hydrogen fuel mixture is provided that includes at least one liquid-distributing agent (LDA) 210 that is mixed uniformly or non-uniformly in the fuel mixture to temporally or spatially control or enhance the delivery of a liquid reactant 208. The LDA 210 is preferably hydrophilic such that the agent attracts water and gets readily dissolved. The LDA 210 also prevents the local precipitation of any substance used in the fuel mixture by drawing enough water to prevent any precipitation of chemical substances used in the fuel mixture. The non-liquid fuel mixture also includes at least one anti-caking agent at a level of 0.1 and 10 weight percent of the total fuel mixture. The fuel mixture further includes at least one binder or form-stabilizing agent, at least one hydride, and at least one activating agent.

The LDA 210 can include hydrophilic polymers, carbohydrates or sugar alcohols. According to the current invention, the hydrophilic polymer includes poly alkyl (acrylic) acid and its salt, where the poly alkyl (acrylic) acid and its salt can include poly(acrylic acid), poly(α-ethylacrylic acid), poly(α-propylacrylic acid), poly(methacrylic acid), poly(sodium acrylate), poly(sodium methacrylate), poly(2-hydroxyethyl methacrylate), or polyacrylamide. The hydrophilic polymers can include poly(N,N-dimethyl acrylamide), poly(N-isopropyl acrylamide), poly(ethylene glycol) or poly(ethylene oxide). Here, the poly(ethylene glycol) and poly(ethylene oxide) can include poly(ethylene glycol) methylether (initiator based on methoxy ethanol), poly(ethylene glycol) with disulfide linkage, poly(ethylene glycol) methylether (initiator based on 2-methoxy propanol), poly(ethylene glycol) monoethyl ether (nitiator based on ethoxy ethanol), poly(ethylene glycol) dimethyl ether, poly(ethylene glycol) mono-benzylether, poly(ethylene glycol) dibenzylmethylene terminated (initiator based on diphenyl methylene), poly(ethylene glycol) dimethylamine and hydroxy terminated, poly(ethylene glycol) dimethylamine or methoxy terminated. The hydrophilic polymers can include poly(methyl vinyl ether), poly(2-vinyl N-methylpyridinium iodide), poly(4-vinyl N-methylpyridinium iodide), poly(N-vinyl imidazole-quaternized with CH3I), poly(ethylene imine), poly(vinylamine) with poly(vinyl carboxylic acid amide), or poly(styrene sulfonic acid) and its salt. Here, the poly(styrene sulfonic acid) and its salt can include poly(styrene sulfonic acid) dialysed, poly(styrene sulfonic acid), undialysed, poly(styrene sulfonic acid cesium salt), dialysed, poly(styrene sulfonic acid cesium salt), undialysed, poly(styrene sulfonic acid sodium salt), dialysed, poly(styrene sulfonic acid sodium salt), or undialysed poly(vinyl alcohol). Further, the poly(vinylamine) and poly(vinyl carboxylic acid amide) can include poly(N-vinylamine), poly(N-vinyl formamide), poly(N-vinyl isobutyramide), or poly(N-vinyl pyrrolidone). The carbohydrates can include monosaccharides such as glucose, fructose, galactose, xylose, ribose disaccharides such as sucrose or polysaccharides such as cellulose, starch, chitin, dextran (dextrin), or maltodextrin. The sugar alcohols can include glycol, glycerol, erythritol, threitol, arabitol, xylitol, ribitol, mannitol, sorbitol, dulcitol, iditol, isomalt, maltitol, lactitol, or polyglycitol.

The LDA 210 further has material that can include microcrystalline cellulose, carboxymethyl cellulose, methyl cellulose, alginic acid, dibasic calcium phosphate, dextrates, calcium sulfate dehydrate, or compressible sucrose.

The hydride is at least one chosen from any chemical hydrides such as sodium borohydride, lithium borohydride, lithium aluminum hydride, lithium hydride, sodium hydride, magnesium hydride, and calcium hydride.

The activating agent can include an acidic catalyst where the acidic catalyst can include boric acid, malic acid, succinic acid, oxalic acid, citric acid, tartaric acid, malonic acid, boric oxide, mucic acid, calcium chloride, sodium borofluoride, phthalic acid, salicylic acid, alum, benzoic acid, phthalic anahydride, sulfamic acid, ammonium alum, ammonium chloride, maleic anahyrdride, sodium acid sulfate, sodium diacid phosphate, aluminum sulfate, maleic acid, calcium chloride or ammonium carbonate.

The activating agent can further include a metallic catalyst, where the metallic catalyst can include colloidal platinum, platinized asbestose, platinum oxidation catalyst, copper-chromic oxide, activated charcoal, Raney nickel, manganese(II) chloride, iron(II) chloride, cobalt(II) chloride, nickel(II) chloride, or copper(II) chloride.

Further, the activating agent can include at least one salt such as alkaline earth metals, alkali metals or halides. The halides can include MgCl₂, BeF₂, BeCl₂, BeBr₂, BeI₂, MgF₂, MgBr₂, MgCl₂, MgI₂, CaF₂, CaCl₂, CaBr₂, CaI₂, LiF, LiCl, LiBr, LiI, NaF, NaCl, NaBr, NaI, KF, KCl, KBr, KI, Li₂S, or Li₂Se. Finally, other candidates of activating agents include at least one of Cu, Co, Ni, Pt, Pd, Fe, Ru, Mn, and Cr.

According to one embodiment, the invention is liquid reactant distribution mixture that includes a fuel (such as sodium borohydride), at least one accelerator, at least one LDA, at least one anti-caking agent, and at least one form-stabilizing agent or binder. The at least one accelerator can include a metallic catalyst, a mixture of acidic and metallic accelerators, an acidic accelerator dissolved in a liquid reactant, a metallic accelerator dissolved in a liquid reactant, an acidic accelerator partially mixed in solid mixture and partially dissolved in liquid reactant, or a metallic accelerator partially mixed in solid mixture and partially dissolved in liquid reactant.

According to the current invention, the acidic accelerator can include oxalic acid, succinic acid, malonic acid, citric acid, tartic acid, malic acid, boric acid mucic acid, calcium chloride sodium borofluoride phthalic acid, salicylic acid, alum, bezoic acid, phthalic anhydride, sulfamic acid ammonium alum, ammonium chloride, maleic anhydride, sodium acid sulfate, sodium diacid phosphate, aluminum sulfate, or ammonium carbonate.

The form-stabilizing agent can include starch, methyl cellulose, hypromellose, microcrystalline cellulose, dibasic calcium phosphate, dextrate, sucrose, or polyethylene glycol. The liquid distribution mixture is compacted to form a solid structure, where the solid structure has a shape that can include a rod, a cylinder, a tube, a plate, a thin sheet, a block, micro-spheres, macro-spheres or powder form. The liquid distribution mixture is uniformly mixed into a gel or paste.

The liquid reactant distribution mixture can further include an anti-foam agent, where the anti-foam agent includes alcohols such as butyl alcohol, hexyl alcohol, or organosilicon compounds.

In another aspect, the organosilicon compounds can include polydimethylsiloxane, polyhydrosiloxane, and silica particles.

The invention further includes reaction control mechanisms to ensure the stable and repeatable performance of a hydrogen system for both continuous and on/off operation. Stable hydrogen generation relies on how uniform and constant reaction interface is maintained between a fuel and liquid reactant. Most of SBH-based hydrogen systems use an alkaline-stabilized SBH solution as its fuel. The reaction control of such a liquid fuel is achieved by pumping a designated amount of the fuel to catalysts. However, the solution type SBH fuel is less favored due to its low energy density. While solid fuels have higher energy density, their further development has been hampered by difficulty in achieving reliable reaction control. The reaction control of a solid SBH system relies on both the pumping rate of liquid reactants and the size of a reaction interface. In practical cases, volatile hydrolysis reaction at the interface leaves cavities or voids when the generated products flow away from the interface. This results in a non-contact between a fuel surface and liquid delivery medium such as a nozzle or wick. When this occurs, the performance of hydrogen generation system degrades over time. The performance of the fuel system becomes unpredictable when it is restarted after a stop period from the previous run. Typically, when the fuel system is investigated after its operation for a certain period, large gaps or voids are observed between the non-reacted surface of the solid fuel and the liquid delivery medium (LDM) such as a nozzle, wick, or membrane. This lack of control in maintaining constant and intact boundary between a solid fuel and liquid delivery medium has been the largest obstacle to achieving reliable performance of a solid fuel system.

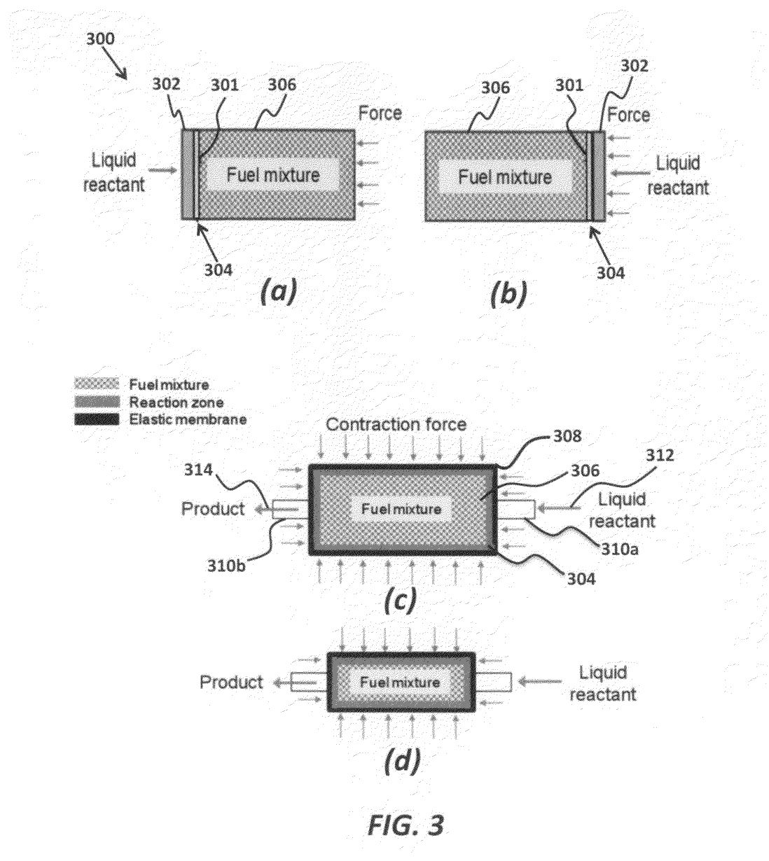

To address these issues, a moving boundary interface (MBI) is provided that ensures a constant contact between a solid fuel and LDM. The MBI includes either physically bringing the reacting surface of a solid fuel in contact with a stationary LDM, or bringing an LDM in contact with the varying contour of the reacting surface of a solid fuel. Physically moving one boundary to another includes, but is not limited to spring force, gas (preferably H₂) pressure, or elastic membrane. FIGS. 3a-3d show schematic diagrams of example moving boundary interface (MBI) designs. MBI systems 300 use compression force on at least one side of a solid fuel mixture. A compression force can be applied either to the side close to reaction zone or the opposite side of the fuel mixture. Other example utilizes an elastic membrane to apply compression force around a solid fuel mixture. When a fuel mixture is consumed and decreases in its volume, the elastic membrane shrinks and maintains its continuous contact to the surface of a fuel mixture. FIGS. 3a-3b show one embodiment of an MBI system 300 having an MBI 301 that utilizes compression force in order to maintain a constant contact between LDM 302 and the unreacted surface (reaction zone) 304 of the SBH fuel mixture 306. The compression force can be applied either to the opposite side of the LDM 302 (as shown in FIG. 3a) or the LDM side (as shown in FIG. 3b). At the LDM/reaction zone interface 302/304, the hydrolysis occurs and its products are generated. However, the constant compression between the LDM 320 and the surface of the SBH mixture 306 pushes the product away from the LDM/reaction zone interface 302/304 and maintain continuous contact with the unreacted portion of the fuel mixture. FIGS. 3c-3d show another embodiment of an MBI system 300 based on an enclosure made of an elastic membrane 306. Prior to SBH hydrolysis, the elastic membrane 308 tightly encloses a solid fuel mixture 306 (as shown in FIG. 3c). An LDM 310a/310b or engineered path for reactants/products is typically assembled/structured between the surface of the fuel mixture 306 and the elastic MBI 308. When a liquid reactant 312 is pumped into a system, the reaction occurs at the interface between the MBI 308 and LDM 310a. As the reaction progresses further, the volume of the fuel mixture 306 decreases (as shown in FIG. 3b) since the products 314 are continuously pushed away from the reaction zone 304. The elastic membrane 308 shrinks over this varying contour of the fuel mixture 306, providing a continuous contact between the surface of the fuel mixture 306 and the LDM 310a/310b. A desired material to form an MBI 308 should be able to conform to the surface of a shrinking fuel mixture 306. Candidate materials include, but are not limited to, any elastic or rubbery materials (such as latex, silicone, viton, polyurethane, neoprene, buna-N, PTFE, ePTFE, perfluoroelastomer, fluorosilicone, Aflas, or Hytrel . . . etc), elastic fabrics, heat shrinkable fabrics, or spring sheets.

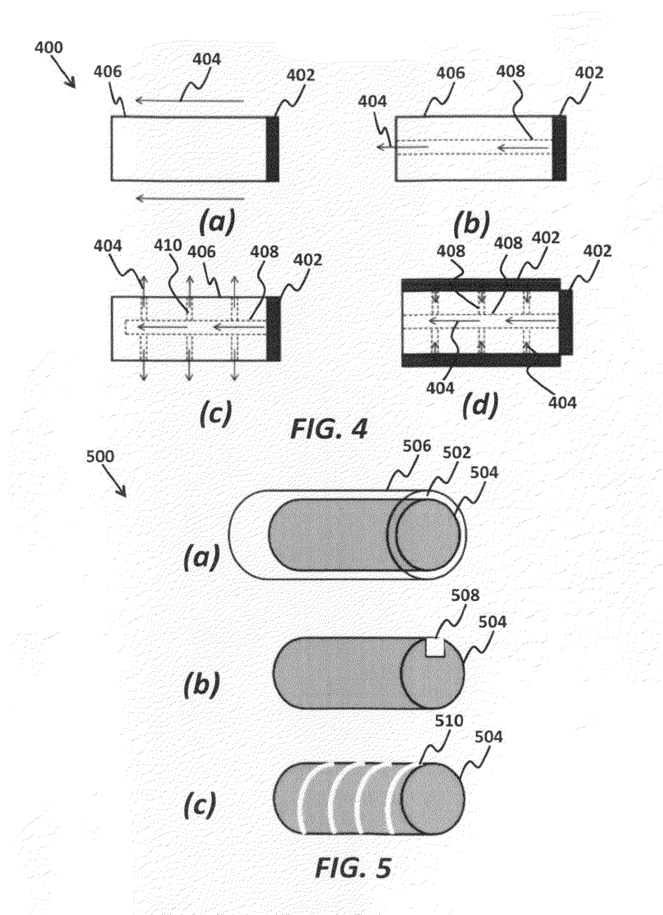

When a non-liquid fuel is employed and the hydrolysis reaction is induced at any surface of the solid fuel, the hydrolysis products need to be continuously removed from a reaction zone to ensure a clean contact between an LDM and the unreacted surface of the solid fuel. Providing clear and engineered pathways for product removal prevents any unexpected failure such as uncontrolled pressure buildup due to the product clogging, the entry disruption of liquid reactants, or the uncontrolled form-factor dismantling of a solid fuel. According to the current invention, for product removal of a non-liquid fuel is provided. FIGS. 4a-4d show schematic diagrams of examples of product-guide designs 400 in a solid fuel mixture (cylindrical shape). Products are guided outside fuel surface, through internal guide, from internal guide to outside through holes to sides, or from outside to inside, thus illustrating how hydrolysis products can be removed from a reaction zone in multiple ways. In one embodiment, when SBH hydrolysis reaction occurs at one side of a cylindrical fuel 402, its resulting products 404 can be guided externally around the fuel body 406 using a number of configurations such as through internal conduits 408 (see FIG. 4b), from internal conduits 408 to outside through holes 410 in a radial direction (as shown in FIG. 4c), or from a reaction zone 402 at the outside surface of a fuel cylinder to internal conduits 412, and to outside again (as shown in FIG. 4d).

The detailed dimension and pattern of this product guide can be further engineered for the operation conditions of each fuel system. FIGS. 5a-5c show examples of engineered guides for product disposal 500. Hydrolysis occurs on at least one side of a fuel mixture, then product flow is generated and exits through features such as a concentric gap between a fuel mixture and the enclosure, channels shaped on the fuel body, or spiral channels shaped on the fuel body for orientation-independent performance. For example, a gap 502 disposed between the fuel surface 504 and enclosure 506 (see FIG. 5a) can act as a product guide. When hydrolysis occurs either on a radial or longitudinal side of the cylindrical fuel, the concurrently-generated products can flow through the concentric gap 502 and exit the fuel zone (not shown). Another embodiment (see FIG. 5b) shows at least one engineered channel 508 structured in the compacted body of a fuel mixture 504. Further detailed dimension and geometry of this channel 509 can determine the flow kinetics of products and allow fine tuning of product disposal. Another embodiment (see FIG. 5c) shows a spiral channel 510 structured on the body of a fuel mixture 504 in order to mitigate orientation-dependency in the product disposal.

Orientation-dependent consumption at a certain location of a fuel, in particular of solid type SBH fuels, due to gravity, often causes the uncontrolled dismantling of the fuel form factor, resulting in uncontrolled hydrogen generation. Even when the pumping rate of a liquid reactant is maintained constant, orientation change of the system causes sudden change in hydrogen generation rate. This typically occurs when there is a surplus of a liquid reactant or the reactant is not contained properly at the desired reaction zone of a system. The surplus or leaking reactant is typically pooled at the bottom of the fuel by gravity. This pooled reactant starts unwanted SBH hydrolysis at a location away from the reaction zone, resulting in the uncontrolled fuel consumption. This orientation-dependency issue is the best overcome by combining the embodiment of the MBI 308 (see FIGS. 3c-3d) and the use of symmetrical guide for product removal spiral channels 510 (see FIG. 5c).

According to another aspect of the invention designs and materials for multi-step filtration of highly viscous products are provided, where the highly viscous products result from hydrolysis of a sodium borohydride reaction. Hydrogen gas needs separation from other products of SBH hydrolysis but the separation, i.e filtration, becomes more challenging with the highly viscous SBH product. The hydrolysis of SBH generates hydrogen and boron oxides that have relatively low solubility in most liquid reactants (such as water). There are also additives typically included in a fuel mixture for facilitation of the SBH hydrolysis as explained in the previous section. Furthermore, since a non-liquid fuel mixture reacts at a near-stoichiometric ratio of the fuel and a liquid reactant (e.g. water), the SBH hydrolysis generates highly viscous products. This highly viscous product is likely to result in a high-pressure drop across filters or even clogging in the filters.

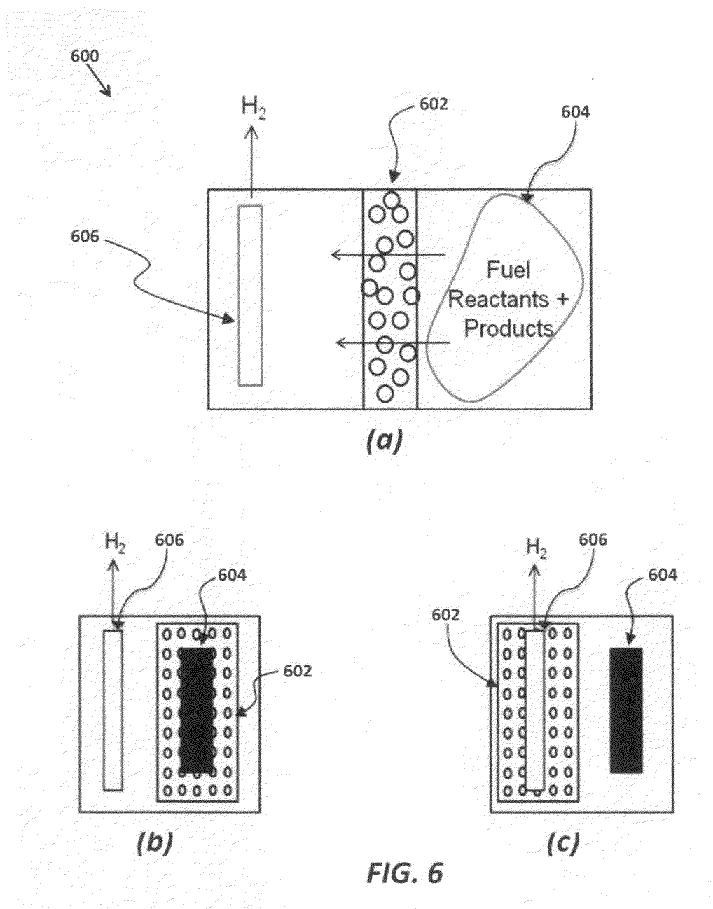

In order to avoid this filter failure, the invention provides a filter set having single or multiple layers of product separation media installed between a fuel mixture and gas separating membrane. FIGS. 6a-6c show schematic drawings of some layout variations 600 of product separation media 602, including product separation media 602 disposed between a mixture of fuel and products 604 and a gas separating membrane 606, and enclosing a fuel mixture and products 604, or enclosing a gas separation filter 606. The layout of a fuel mixture 604, product separation media 602, and gas separating membrane 606 can be optimized for the best filter performance. In one embodiment, a porous (open cell) foam structure 602 is placed between a fuel mixture 604 and a gas separating membrane 606 such that all products from hydrogen reaction can be separate from the gas membrane 606 (see FIG. 6a). In other embodiment, a fuel mixture 604 is enclosed in a hydrophobic (more preferred) or hydrophilic foam structure 602 through which hydrogen gas passes, leaving any gas bubble, liquid, or solid products within the foam structure 602 (see FIG. 6b). This enclosure-style product separation medium localizes a liquid reactant close to an unreacted fuel mixture to minimize any runaway of the liquid reactant without participating hydrogen reaction. According to another embodiment, when there is less need for localizing the liquid reactant, then a gas separation medium 606 can be enclosed by a product separation medium 602 to prevent any contamination by products from the reaction (see FIG. 6c). Additional foam (not shown) such as open cell, single or multiple, hydrophilic or hydrophobic, can be applied either inside or outside the first open cell foam 602 structure to minimize any product leakage through the first foam structure 602.

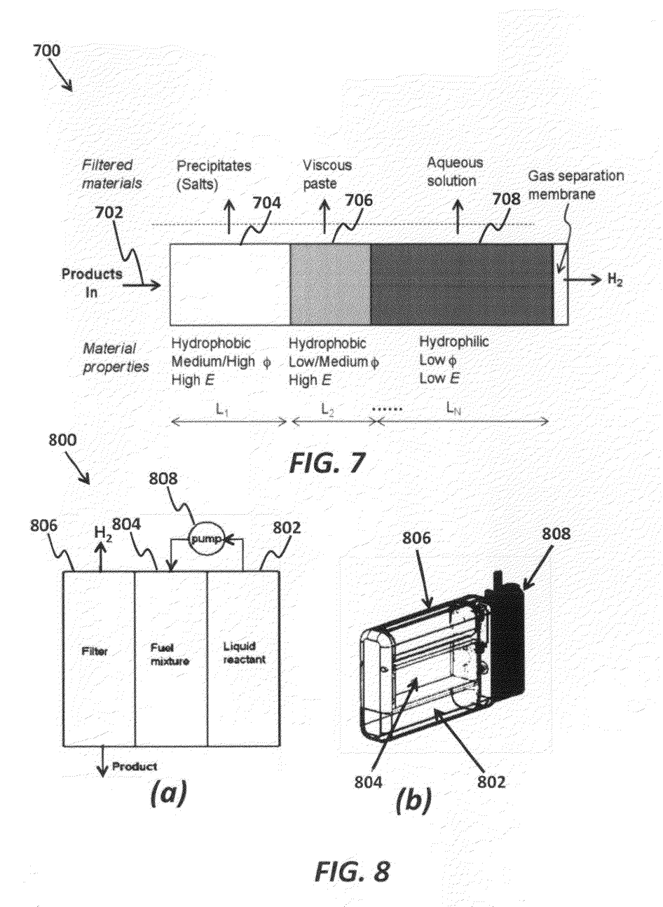

In addition to the layout variations 600 provided above, the current invention provides specific design and selection of filter materials for the highly viscous products from SBH hydrolysis. Products from the current sodium borohydride (SBH) mixture consist of precipitated particulates (mostly boron oxide salts), hydrogen gas, and highly viscous paste (mixture of boron oxide salts, acid accelerators, surplus of water, and other additives). These products of different physical properties need to be filtered out using multiple steps. According to another embodiment, FIG. 7 shows a schematic drawing of a multi-stage filter configuration 700. Here, φ is porosity, E is Young's modulus, and L_{N} indicates the length of each filter stage. Product enters filter set 700 into the most hydrophobic and stiff filter with the highest porosity, then sequentially filtered out until only H₂ gas remains. As shown in FIG. 7, the particulate product 702 is filtered first by the largest pores 704 of hydrophobic porous structures. After this first filtering, only gas, viscous paste, and liquid are able to pass to the next filter material 706. This first filter 704 (hydrophobic and containing large pores) is also selected to have higher mechanical stiffness to avoid any compression that might lead to closure of the pores. As a material for the next stage filter 706, relatively hydrophilic and fibrous material, is selected. This material filters any aqueous substance and allows only hydrogen gas to pass through the material. At the final stage, a gas separation filter 708 (e.g. ePTFE filter) is used to allow pure hydrogen gas to exit the system. Number, volume, and types of filters at each stage can be custom-adjusted to meet the required performance of filtration for products with varying properties.

In a preferred embodiment of the invention, a fuel mixture includes a fuel (sodium borohydride), acidic accelerators (acids such as malic acid, boric acid, succinic acid, or oxalic acid), a liquid distributing agent (polyethylene glycols, compressible sugars, poly saccharides, or glass fibers), and a binder (polyethylene glycol, poly saccharides, alginic acid, or cellulose). This mixture can either be compacted to form a solid structure such as a rod, cylinder, rectangle, micro-/macro-spheres or other forms, or be in its powder form, when the powder mixture is packaged in a fuel pack. Acid accelerators for this mixture are discussed above. Table I shows some exemplary compositions fuel mixtures and their mixing ratios.

TABLE I
LIST OF PREFERRED FUEL MIXTURE AND MIXING RATIO

| | | | Liquid | Anti- | Anti- |
|---|---|---|---|---|---|
| No | Fuel | Accelerator | distributor/Binder | caking | foam |
| 1 | SBH | Succinic acid | Compressible sugar | Silica | n/a |
| | (15 g) | (15 g) | (1 g) | (0.3 g) | |
| 2 | SBH | Boric acid | Compressible sugar | Silica | n/a |
| | (15 g) | (15 g) | (1 g) | (0.3 g) | |
| 3 | SBH | Boric acid | PEG 6000 | Silica | n/a |
| | (15 g) | (15 g) | (1 g) | (0.3 g) | |
| 4 | SBH | Malic acid | Compressible sugar | Silica | n/a |
| | (15 g) | (15 g) | (1 g) | (0.3 g) | |
| 5 | SBH | Malic acid | PEG 6000 | Silica | n/a |
| | (15 g) | (15 g) | (1 g) | (0.3 g) | |
| 6 | SBH | Malic acid | PEG 6000 | Silica | n/a |
| | (20 g) | (10 g) | (1 g) | (0.3 g) | |
| 7 | SBH | Malic acid | PEG 6000 | Silica | (0.3 g) |
| | (20 g) | (10 g) | (1 g) | (0.3 g) | |

* Note)
SBH (Sodium Borohydride), PEG 6000 (Polyethylene Glycol, Mw = 6,000), Anti-foam (Dow Corning Brand)

FIGS. 8a-8b show a schematic and a CAD model, respectively, of the current embodiment of a hydrogen generator system 800 that includes a liquid chamber 802, a fuel chamber 804, a filter chamber 806, and a pump 808. The liquid chamber 802 contains a plastic bag made out of polyethylene/BON material that stores deionized water. The DI water is pumped into the fuel chamber 804 and reaches an LDM (not shown). Hydrogen reaction occurs in the fuel chamber 804 at a defined reaction zone, then the resulting products flow into the filter chamber 806. The products are filtered out and only hydrogen gas exits the hydrogen generator system 800.

In a further embodiment, hydrogen generation is regulated by pumping of a liquid reactant, preferably clean filtered water. One pump, according to the current invention, is a diaphragm pump and the delivery of liquid is controlled by on/off, stroke volume, and pumping frequency. With a pre-determined stroke volume, the rate of hydrogen generation is mainly controlled by pumping frequency. In order to increase a hydrogen generation rate, the fuel cell sends a signal for an increased pumping frequency for accelerated hydrogen generation. Other types of pumps suitable for a hydrogen generator system include peristaltic pumps, and electro-osmotic (EO) pumps.

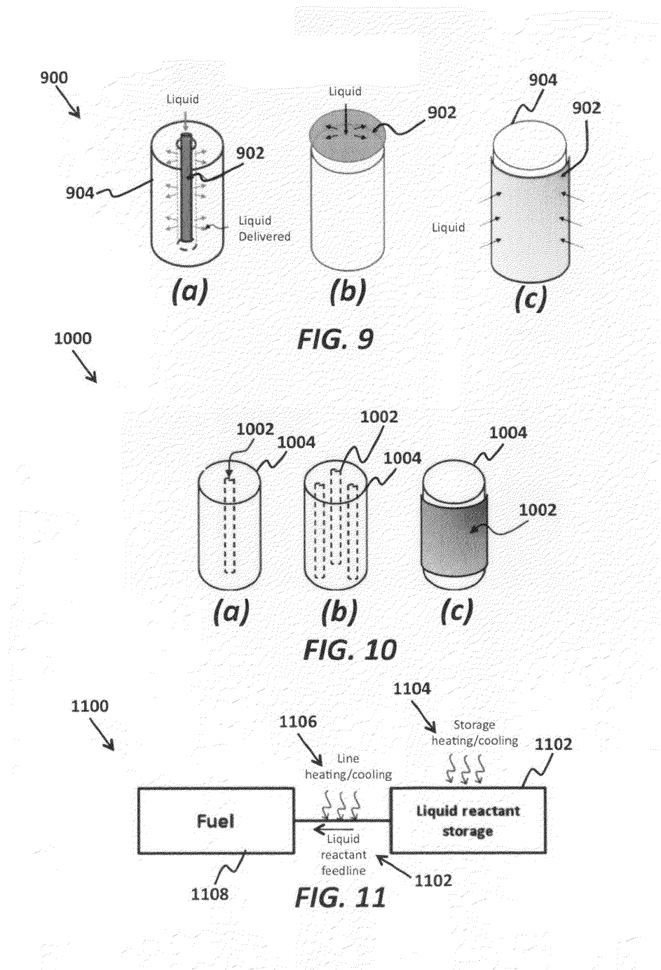

According to the current invention, a liquid-delivery medium (LDM) can be porous media, wicking fibers, wicking foams, or wicking fabrics such that any liquid flowing into the LDM can spread out uniformly to the fuel mixture. FIGS. 9a-9c show schematic diagrams of some assemblies 900 of an LDM 902 and fuel mixture 904 in a form of a nozzle, a plane, or an envelope, respectively. Specifically, an LDM 902 can be inserted into a conduit of a solid fuel 904 (see FIG. 9a), assembled at one side of a solid fuel 904 (see FIG. 9b), enclose a solid fuel 904 like an envelope (see FIG. 9c) in contact or proximal to a surface of the solid fuel 904.

According to another embodiment, a multi-stage filter for product separation can include a stiff hydrophobic material with high porosity (filter #1), a stiff hydrophobic material with medium porosity (filter #2), and a soft hydrophilic material with the least porosity (filter #3). Preferably, the filter #1 is placed at a product entrance to filter large particulates, then the filter #2 to filter viscous pasty components of products, and the filter #3 is placed at the last place to absorb any liquid. Typically, a gas separation membrane (e.g. silicone, PTFE, or ePTFE based materials) is placed after the filter #3. Preferred choice of hydrophobic porous materials includes, but is not limited to, synthetic nylon wools, silicone foams, rubber foams, polyethylene foams, viton foams, polyurethane foams, neoprene foams, or vinyl foams. Preferred choice of hydrophilic materials includes, but is not limited to, acryl yarns, polyimide foams, carbon felts, polypropylene felts. A preferred set of filters can include about 10˜20% (w/w) of a synthetic nylon wool (grade #2 coarse, McMaster Carr, CA) as a filter #1, about 10˜40% (w/w) of another synthetic nylon wool (grade #1 medium, McMaster Carr, CA), and about 40˜80% (w/w) synthetic acryl yarn (4 medium, Lion Brand Yarn Company, NY).

In a further embodiment of the invention, a local heating and cooling of a fuel or reaction chamber can assist faster start and stop function of hydrogen generation is provided. Application to the system 1000 (see FIGS. 10a-10c) of a local heating and cooling apparatus 1002 to accelerate or decelerate hydrolysis of sodium borohydride, especially during stop and start, improves system performance and user safety. According to the current embodiment, the temperature control provides enhanced “stop/start” kinetics of hydrogen generation, particularly for “solid fuel mixture” or “liquid reactants” instead of “chemical hydride solution”.

As shown in FIG. 10, a local thermal controlling apparatus 1002 can be embedded in a fuel mixture 1004 (see FIG. 10a-10b), or wrap around the fuel mixture 1004 (see FIG. 10c). Temperature of a fuel mixture is monitored and feed-back controlled (not shown) to maintain an optimal temperature to generate a required amount of hydrogen. In particular, when the hydrogen generator is initiated at a room temperature, the instant heating of a fuel mixture will minimize a transient period until the full generation rate is achieved. Using instantaneous cooling of a fuel mixture, the shut-off time of hydrogen reaction can be reduced as well. Examples of such a local thermal controlling apparatus include, but not limited to, electrical or non-electrical heating pad, peltier elements, heat pumps, or other heat exchange devices using conduction, radiation, or natural or forced convection.

According to another embodiment of the invention, provided is an apparatus disposed for the pre-heating of a liquid reactant before it reaches the reaction chamber can accelerate hydrogen generation after a system was off. As shown in FIG. 11, the liquid reactant 1102 can be heated 1104 in its storage and maintained at a desirable temperature or the liquid reactant 1102 can be heated 1106 while it is being fed into the reaction chamber 1108. The latter case is more desirable to minimize energy consumption. This local heating can also be achieved by the local thermal controlling apparatus as listed in the previous paragraph.

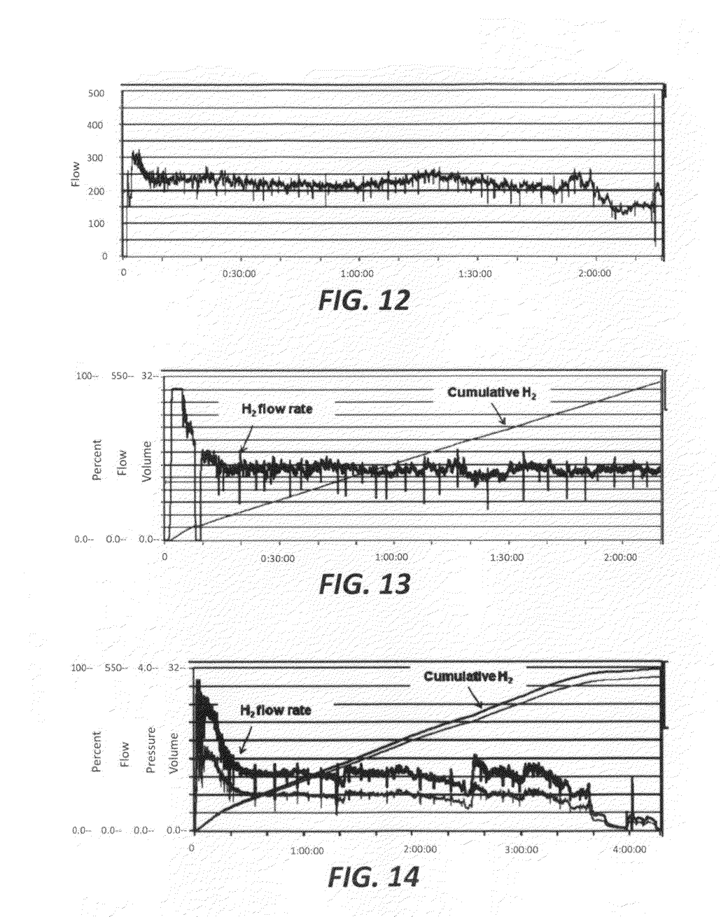

In one exemplary embodiment of the invention, a fuel mixture was prepared by grinding and mixing each component at a pre-determined mixing ratio. In this example, 15 gram of succinic acid, 1 gram of compressible sugar, 0.3 gram of silica, and 15 gram of sodium borohydride were weighed and poured into a grinding bowl. After uniform mixing under a dry condition, preferably in a humidity-controlled glove box, the powder mixture was poured into a compaction mold. Then, the powder mixture was compressed under a pressure of around 1,000˜2,000 psi to form a compacted cylinder with a conduit at its center. This compacted fuel pill was assembled with a nozzle type LDM 902 (see FIG. 9a), gas separating membrane, and tubes in a plastic bag. A predetermined amount (typically 30˜60 mL) of distilled water was stored in a separate bag and connected via a diaphragm pump to the liquid nozzle. A pumping stroke was set at 0.035 mL/stroke and the pumping frequency was set at 10 strokes/minute. The hydrogen gas was dehydrated through a drying column filled with desiccants, then the flow rate was measured using a flow meter. The pump was controlled by a LabView controller and the flow rate and other relevant data were collected and recorded. The FIG. 12 shows the flow rate of hydrogen generated at a constant pumping rate, where shown is the H₂ evolution profile of Mixture No. 1 from TABLE 1 (SBH 15 g, Succinic acid 15 g, Compressible sugar 1 g, Silica 0.3 g), X-axis indicates time in [hr:min:sec] and Y-axis indicates hydrogen flow rate in [sccm].

According to another exemplary embodiment of the invention, fuel mixture contained 20 gram of sodium borohydride, 10 gram of malic acid, 1 gram of PEG6000 (Polyethylene Glycol, Mw=6,000), and 0.3 gram of silica was used. Other conditions were the same as the previous example. FIG. 13 shows the flow rate and cumulative amount of hydrogen generated at a constant pumping rate, where shown is the H₂ evolution profile of Mixture No. 6 from TABLE 1 (SBH 20 g, Malic acid 10 g, PEG 6000 1 g, Silica 0.3 g) X-axis indicates time in [hr:min:sec] and Y-axis indicates hydrogen flow rate in [sccm]. The cumulative amount of hydrogen produced over time is depicted in liters and percentage of total theoretical amount.

According to a further exemplary embodiment of the current invention, the fuel mixture contains 20 gram of sodium borohydride, 10 gram of malic acid, 1 gram of PEG6000 (Polyethylene Glycol, Mw=6,000), and 0.3 gram of silica. Other conditions were the same as the previous example. The orientation of the fuel bag was changed at multiple time points, such as 1 hr 20 min, 2 hr 32 min, and 3 hr. FIG. 14 shows the flow rate and cumulative amount of hydrogen generated at a constant pumping rate, where shown is the H₂ evolution profile of Mixture No. 7 from TABLE 1 (SBH 20 g, Malic acid 10 g, PEG6000 1 g, Silica 0.3 g). Orientation was changed at times, 1 hr 20 min, 2 hr 32 min, and 3 hr. X-axis indicates time in [hr:min:sec] and Y-axis indicates hydrogen flow rate in [sccm]. The cumulative amount of hydrogen produced over time is depicted in liters and percentage of total theoretical amount.

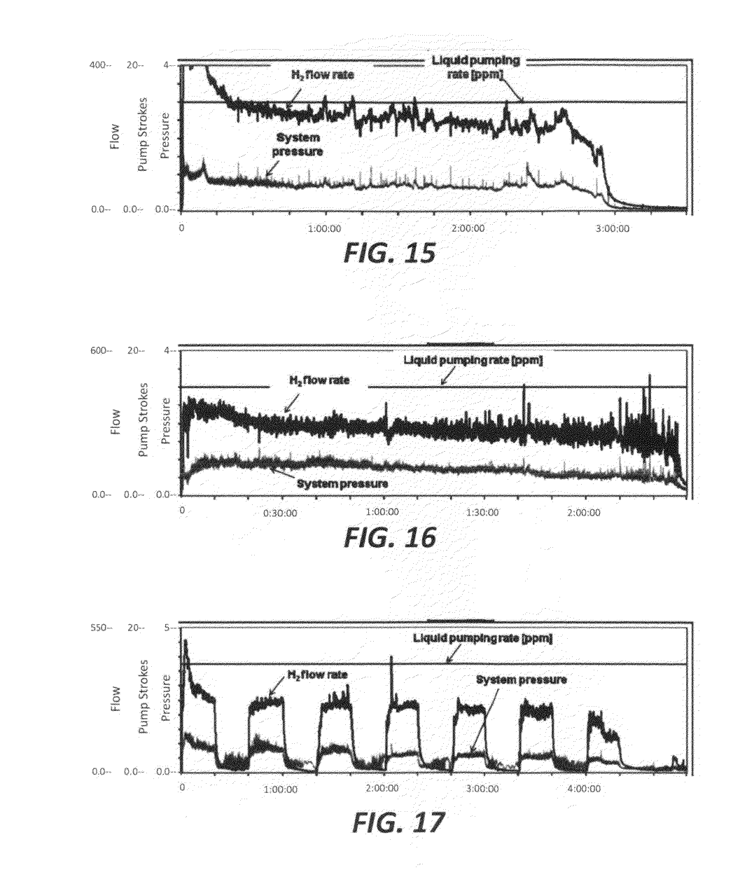

According to another exemplary embodiment of the invention, a synthetic polypropylene felt (McMaster Carr, CA) was used as a planar LDM 902 and placed in one side of a cylindrical fuel pill 904 (see FIG. 9b). Then the pill was under a compression force by a spring from the other side of the fuel pill 306 (see FIG. 3a). The fuel mixture contained 20 gram of sodium borohydride, 10 gram of malic acid, 1 gram of PEG6000 (Polyethylene Glycol, Mw=6,000), and 0.3 gram of silica. Other conditions were the same as the previous example. Shown in FIG. 15, hydrogen gas was generated at a stable flow rate of between 250 and 300 sccm for about 3 hrs, while maintained relatively low pressure buildup (1 psi or lower) within the system. Specifically, FIG. 15 shows a H₂ evolution profile of H2 generation system when planar type of LDM made of synthetic polypropylene felt was used. Mixture No. 7 (SBH 20 g, Malic acid 10 g, PEG6000 1 g, Silica 0.3 g) was used as a fuel mixture. Orientation was maintained without a change.

In yet another exemplary embodiment of the invention, a cylindrical solid fuel 306 is placed in an elastic balloon membrane 308 that has an inlet for liquid reactants 310a and outlet for products to exit 310b (see FIG. 3c). A straight channel 508 as a product path is structured on the surface of the solid fuel 504 (see FIG. 5b). The solid fuel contained 20 gram of sodium borohydride, 10 gram of malic acid, 1 gram of PEG6000 (Polyethylene Glycol, Mw=6,000), and 0.3 gram of silica. A serial filter set used in this experiment was comprised of 3 grams of synthetic nylon wool (grade #2 coarse, McMaster Carr, Los Angeles) for the first stage to filter large particulates, 5 grams of synthetic nylon wool (grade #1 medium, McMaster Carr, Los Angeles) for the second stage to filter viscous pasty components, and 7 grams of acryl yarn (4 medium, Lion Brand Yarn Company, NY). Other conditions were the same as previous embodiments. H₂ flow rate from this configuration is shown in FIG. 16, where shown is a H₂ evolution profile of balloon membrane fuel reactor and serial filter set comprised of nylon wools and acryl yarn.

According to another exemplary embodiment of the invention, a hydrogen generation system described in the previous example was tested under a dynamic condition where a liquid reactant pumping into the system was on for 20 min and off for 20 min. The dynamic performance of the stop/start is shown in FIG. 17. Instantaneous start and stop upon pump on/off was demonstrated, where shown is an example of a H₂ pack with elastic enclosure during dynamic test with 20 min On/20 min Off cycle. Startup and Stop behaves identical every cycle longer than 4 hours of operation until its completion (100% yield of H₂).

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example acid accelerators can be replaced or combined with metal catalysts. The presented invention can be applied to any chemical hydride reacting with any liquid reactant. Multi-stage filter set can be configured in serial, parallel, or combination of serial and parallel steps. Assembly sequence of each filter material can be altered for optimal performance. Physical form of a fuel mixture can be cylindrical, planar, annular, cubic, rectangular, particles, microspheres, beads, pallets, powder, or paste. Acid accelerators can be incorporated in a fuel mixture, or dissolved in the solution of a liquid reactant. Liquid delivery medium (LDM) can be in contact or proximate to the unreacted surface of a fuel mixture. LDM can be hydrophilic or lipophilic. LDM can have relatively large pores or small pores. A hydrogen generation system has a single or multiple LDMs at single or multiple locations. LDM can have a variety of form factors. Solubility modifying agents for hydrolysis products of sodium borohydride can be included in a fuel mixture, filter set, or saturated in the solution of liquid reactants. Liquid reactants can be preheated to assist the resuming function of the system after being turned off. Reaction zone or interface can be preheated to assist the resuming function of the system after being turned off. Heat generated from the exothermic reaction of sodium borohydride reaction can be stored and utilized to assist resuming function after the system being turned off. Heat generated from the exothermic reaction of sodium borohydride reaction can be utilized to preheat liquid reactants. Heat generated from the exothermic reaction of sodium borohydride reaction can be utilized to heat filtration area to lower viscosity of product flowing through filer materials.

All such variations are considered to be within the scope and spirit of the present invention as defined by the following claims and their legal equivalents.

What is claimed is:

1. A chemical hydride liquid reactant distribution mixture comprising:
a. a fuel mixture, wherein said fuel mixture comprises at least one hydride and at least one activating agent;
b. a liquid-distributing agent (LDA)
c. a form-stabilizing agent; and
d. at least one anti-caking agent, wherein said liquid reactant distribution mixture reduces caking and precipitation while promoting said liquid reactant distribution, wherein said chemical hydride liquid reactant distribution mixture generates hydrogen via hydrolysis.

2. The liquid reactant distribution mixture of claim 1, wherein said LDA is selected from the group consisting of hydrophilic polymers, carbohydrates and sugar alcohols.

3. The liquid reactant distribution mixture of claim 2, wherein said hydrophilic polymer comprises poly alkyl (acrylic) acid and its salt, wherein said poly alkyl (acrylic) acid and its salt is selected from the group consisting of as poly(acrylic acid), poly(α-ethylacrylic acid), poly(α-propylacrylic acid), poly(methacrylic acid), poly(sodium acrylate), poly(sodium methacrylate), poly(2-hydroxyethyl methacrylate), and polyacrylamide.

4. The liquid reactant distribution mixture of claim 2, wherein said hydrophilic polymers are selected from the group consisting of poly(N,N-dimethyl acrylamide), poly(N-isopropyl acrylamide), poly(ethylene glycol) and poly(ethylene oxide).

5. The liquid reactant distribution mixture of claim 4, wherein said poly(ethylene glycol) and poly(ethylene oxide) is selected from the group consisting of poly(ethylene glycol) methylether (initiator based on methoxy ethanol), poly(ethylene glycol) with disulfide linkage, poly(ethylene glycol) methylether (initiator based on 2-methoxy propanol), poly(ethylene glycol) monoethyl ether (nitiator based on ethoxy ethanol), poly(ethylene glycol) dimethyl ether, poly(ethylene glycol) mono-benzylether, poly(ethylene glycol) dibenzylmethylene terminated (initiator based on diphenyl methylene), poly(ethylene glycol) dimethylamine and hydroxy terminated, poly(ethylene glycol) dimethylamine and methoxy terminated.

6. The liquid reactant distribution mixture of claim 2, wherein said hydrophilic polymers are selected from the group consisting of poly(methyl vinyl ether), poly(2-vinyl N-methylpyridinium iodide), poly(4-vinyl N-methyl pyridinium iodide), poly(N-vinyl imidazole-quaternized with CH3I), poly(ethylene imine), poly(vinylamine) with poly(vinyl carboxylic acid amide), and poly(styrene sulfonic acid) and its salt.

7. The liquid reactant distribution mixture of claim 6, wherein said poly(styrene sulfonic acid) and its salt is selected from the group consisting of poly(styrene sulfonic acid) dialysed, poly(styrene sulfonic acid), undialysed, poly(styrene sulfonic acid cesium salt), dialysed, poly(styrene sulfonic acid cesium salt), undialysed, poly(styrene sulfonic acid sodium salt), dialysed, poly(styrene sulfonic acid sodium salt), and undialysed; poly(vinyl alcohol).

8. The liquid reactant distribution mixture of claim 6, wherein said poly(vinylamine) and poly(vinyl carboxylic acid amide) is selected from the group consisting of poly(N-vinylamine), poly(N-vinyl formamide), poly(N-vinyl isobutyramide), and poly(N-vinyl pyrrolidone).

9. The liquid reactant distribution mixture of claim 2, wherein said carbohydrates are selected from the group consisting of monosaccharides disaccharides and polysaccharides.

10. The liquid reactant distribution mixture of claim 2, wherein said sugar alcohols are selected from the group consisting of glycol, glycerol, erythritol, threitol, arabitol, xylitol, ribitol, mannitol, sorbitol, dulcitol, iditol, isomalt, maltitol, lactitol, or polyglycitol.

11. The liquid reactant distribution mixture of claim 2, wherein said LDA further comprise material selected from the group consisting of microcrystalline cellulose, carboxymethyl cellulose, methyl cellulose, alginic acid, dibasic calcium phosphate, dextrates, calcium sulfate dehydrate, and compressible sucrose.

12. The liquid reactant distribution mixture of claim 2, wherein said LDA comprises a weight percentage of said liquid reactant distribution mixture in a range from 0.1 to 50 percent.

13. The liquid reactant distribution mixture of claim 1, wherein said form-stabilizing agent is selected from the group consisting of starch, methyl cellulose, hypromellose, microcrystalline cellulose, dibasic calcium phosphate, dextrate, sucrose, and polyethylene glycol.

14. The liquid reactant distribution mixture of claim 1, wherein said at least one anti-caking agent is selected from the group consisting of magnesium carbonate, calcium carbonate, silica (silicon dioxide), sodium bicarbonate, sodium ferrocyanide, potassium ferrocyanide, calcium ferrocyanide, bone phosphate, sodium silicate, calcium silicate, magnesium trisilicate, talcum powder, sodium aluminosilicate, potassium aluminium silicate, calcium aluminosilicate, bentonite, aluminium silicate, stearic acid, and polydimethylsiloxane.

15. The liquid reactant distribution mixture of claim 1, wherein said at least one anti-caking agent comprises a weight percentage of said liquid reactant distribution mixture in a range from 0.1 to 10 percent.

16. The liquid reactant distribution mixture of claim 1, wherein said at least one hydride is selected from the group consisting of sodium borohydride, lithium borohydride, lithium aluminum hydride, lithium hydride, sodium hydride, magnesium hydride, and calcium hydride.

17. The liquid reactant distribution mixture of claim 1, wherein said at least one activating agent comprises a acidic catalyst wherein said acidic catalyst is selected from the group consisting of boric acid, malic acid, succinic acid, oxalic acid, citric acid, tartaric acid, malonic acid, boric oxide, mucic acid, calcium chloride, sodium borofluoride, phthalic acid, salicylic acid, alum, benzoic acid, phthalic anahydride, sulfamic acid, ammonium alum, ammonium chloride, maleic anahyrdride, sodium acid sulfate, sodium diacid phosphate, aluminum sulfate, maleic acid, calcium chloride and ammonium carbonate.

18. The liquid reactant distribution mixture of claim 1, wherein said at least one activating agent comprises a metallic catalyst, wherein said metallic catalyst is selected from the group consisting of colloidal platinum, platinized asbestose, platinum oxidation catalyst, copper-chromic oxide, activated charcoal, Raney nickel, manganese(II) chloride, iron(II) chloride, cobalt(II) chloride, nickel(II) chloride, and copper(II) chloride.

19. The liquid reactant distribution mixture of claim 1, wherein said at least one activating agent comprises at least one salt selected from the group consisting of alkaline earth metals, alkali metals and halides.

20. The liquid reactant distribution mixture of claim 19, wherein said halides are selected from the group consisting MgCl₂, BeF₂, BeCl₂, BeBr₂, BeI₂, MgF₂, MgBr₂, MgCl₂, MgI₂, CaF₂, CaCl₂, CaBr₂, CaI₂, LiF, LiCl, LiBr, LiI, NaF, NaCl, NaBr, NaI, KF, KCl, KBr, KI, Li₂S, or Li₂Se. Finally, other candidates of activating agents include at least one of Cu, Co, Ni, Pt, Pd, Fe, Ru, Mn, and Cr.

21. A liquid reactant distribution mixture comprising:
a. a fuel;
b. at least one accelerator;
c. at least one liquid distributing agent (LDA); and
d. at least one form-stabilizing agent or binder.

22. The liquid reactant distribution mixture of claim 21, wherein said at least one accelerator is selected from the group consisting of an acidic accelerator, a metallic catalyst, a mixture of acidic and metallic accelerators, an acidic accelerator dissolved in a liquid reactant, a metallic accelerator dissolved in a liquid reactant, an acidic accelerator partially mixed in solid mixture and partially dissolved in liquid reactant, and a metallic accelerator partially mixed in solid mixture and partially dissolved in liquid reactant.

23. The liquid reactant distribution mixture of claim 21, wherein said fuel comprises sodium borohydride.

24. The liquid reactant distribution mixture of claim 21, wherein said at least one acidic accelerator is selected from the group consisting of oxalic acid, succinic acid, malonic acid, citric acid, tartic acid, malic acid, boric acid mucic acid, calcium chloride sodium borofluoride phthalic acid, salicylic acid, alum, bezoic acid, phthalic anhydride, sulfamic acid ammonium alum, ammonium chloride, maleic anhydride, sodium acid sulfate, sodium diacid phosphate, aluminum sulfate, and ammonium carbonate.

25. The liquid reactant distribution mixture of claim 21, wherein said at least one LDA is selected from the group consisting of hydrophilic polymers, carbohydrates, and sugar alcohols.

26. The liquid reactant distribution mixture of claim 21, wherein said at least one form-stabilizing agent is selected from the group consisting of starch, methyl cellulose, hypromellose, microcrystalline cellulose, dibasic calcium phosphate, dextrate, sucrose, and polyethylene glycol.

27. The liquid reactant distribution mixture of claim 21, wherein said liquid distribution mixture is compacted to form a solid structure, wherein said solid structure has a shape selected from the group consisting of a rod, a cylinder, a tube, a plate, a thin sheet, a block, micro-spheres, macro-spheres and powder form.

28. The liquid reactant distribution mixture of claim 21, wherein said liquid distribution mixture is uniformly mixed into a gel or paste.

29. The liquid reactant distribution mixture of claim 21 further comprises an anti-foam agent, wherein said anti-foam agent comprises alcohols selected from the group consisting of butyl alcohol, hexyl alcohol, and organosilicon compounds.

30. The liquid reactant distribution mixture of claim 21, wherein said organosilicon compounds are selected from the group consisting of polydimethylsiloxane, polyhydrosiloxane, and silica particles.
